(19) United States
(12) Patent Application Publication
(10) Pub. No.: US 2007/0166512 A1
(43) Pub. Date: Jul. 19, 2007

(54) Absorbent Release Sheet

(76) Inventors: Norman L. Jesch, Golden, CO (US); John Cameron Files, Vancouver, WA (US); Thomas Wolford, Yacolt, WA (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/673,130

(22) Filed: Feb. 9, 2007

Related U.S. Application Data
(63) Continuation-in-part of application No. 11/211,858, filed on Aug. 25, 2005.
(60) Provisional application No. 60/604,637, filed on Aug. 25, 2004.

(51) Int. Cl. B32B 3/10

(52) U.S. Cl. 428/138; 428/137

(57) ABSTRACT

Various constructs that absorb exudates from a food item are provided.

### CROSS-REFERENCE TO RELATED APPLICATION

This application is a continuation-in-part of U.S. patent application Ser. No. 11/211,858, filed Aug. 25, 2005, which claims the benefit of U.S. Provisional Application No. 60/604,637, filed Aug. 25, 2004.

### TECHNICAL FIELD

The present invention relates to various constructs having absorbent properties.

### BACKGROUND

Microwave ovens commonly are used to cook food in a rapid and effective manner. Many materials and packages have been designed for use in a microwave oven. During the heating process, many food items release water, juices, oils, fats, grease, and blood (collectively referred to herein as “exudate”). Typically, the exudate pools beneath the food item. While some pooling may enhance browning and crisping of the food item, excessive pooling of exudate may impede browning and crisping. Thus, there is a need for a structure that absorbs excess exudates during storage and cooking of a food item.

### SUMMARY

The present invention generally relates to various materials, structures, pads, sheets, packages, trays, and other constructs that absorb exudates from food item during heating in a microwave oven.

### BRIEF DESCRIPTION OF THE DRAWINGS

The description refers to the accompanying schematic drawings in which like reference characters refer to like parts throughout the several views:

FIG. 1 depicts an exemplary absorbent structure according to various aspects of the invention;

FIG. 2 depicts another exemplary absorbent structure according to various aspects of the invention;

FIG. 3 depicts still another exemplary absorbent structure according to various aspects of the invention;

FIG. 4 depicts yet another exemplary absorbent structure according to various aspects of the invention;

FIG. 5 depicts another exemplary absorbent structure according to various aspects of the invention;

FIG. 6 depicts the absorbent structure of FIG. 3 with perforations, according to various aspects of the invention;

FIG. 7 depicts the absorbent structure of FIG. 4 with perforations, according to various aspects of the invention;

FIG. 8 depicts the absorbent structure of FIG. 5 with perforations, according to various aspects of the invention;

FIG. 9 depicts an exemplary roll of absorbent release sheets according to various aspects of the invention; and

FIG. 10 depicts an exemplary absorbent release sheet used with a conventional tray according to various aspects of the invention.

### DETAILED DESCRIPTION

The present invention relates generally to various absorbent materials, structures, pads, and sheets (sometimes collectively “structures”), and packages, trays, and other constructs (sometimes collectively “constructs”) for use in packaging and heating microwaveable food items. The various structures of the invention feature a non-stick surface for contacting a food item. The various structures and constructs may be used with numerous food items, for example, meat, poultry, bacon, convenience foods, pizza, sandwiches, desserts, and popcorn and other snack foods.

The present invention may be best understood by referring to the figures. For purposes of simplicity, like numerals may be used to describe like features. However, it should be understood use of like numerals is not to be construed as an acknowledgement or admission that such features are equivalent in any manner. It also will be understood that where a plurality of similar features are depicted, not all of such identical features may be labeled on the figures.

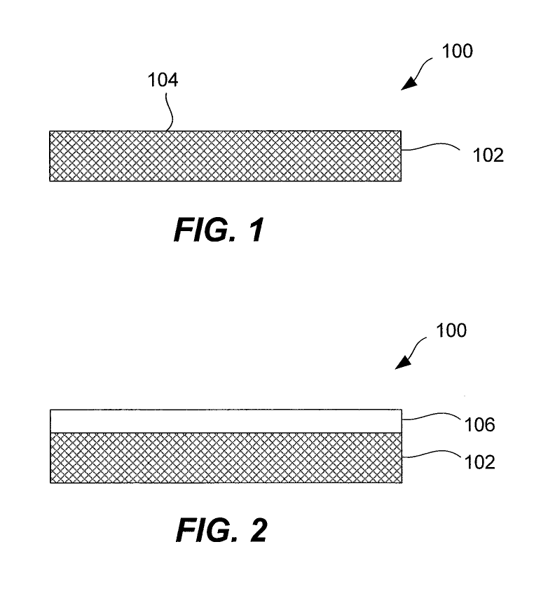

FIG. 1 illustrates a schematic cross-sectional view of an exemplary structure 100 for forming an absorbent release sheet or other construct according to various aspects of the present invention. The structure 100 includes a plurality of superposed and/or adjoined layers. It will be understood that while particular combinations of layers are described herein, other combinations of layers are contemplated hereby.

Viewing FIG. 1, the structure 100 includes an absorbent layer 102 having a non-stick surface 104. The material that forms the absorbent layer 102 may have inherent release characteristics including a generally non-stick surface 104, or may be modified by incorporating a release additive (not shown) into the absorbent layer 102, for example, where the layer is formed from a polymeric material. Alternatively, the structure 100 may be formed by applying a release coating or layer 106 over at least a portion of the absorbent layer 102, as shown in FIG. 2, by, for example, Gravure printing, roll coating and air knife, brush treating, spraying, dipping, wire wound rods, or any combination thereof. In this and other aspects of the invention, the non-stick surface may be continuous or discontinuous and, therefore, in continuous or discontinuous contact with the food item.

The absorbent layer may be formed from any material capable of absorbing exudates from a food item during microwave heating. For example, the absorbent layer may be formed from cellulosic materials, polymeric materials, or a combination thereof, and may be a woven or nonwoven material.

Examples of cellulosic materials that may be suitable for use with the present invention include, but are not limited to, wood fluff, wood fluff pledgets, tissue, and toweling. The cellulosic material may comprise pulp fibers, or fibers from other sources, for example, flax, milkweed, abaca, hemp, cotton, or any combination thereof. Processes used to form cellulosic materials are well known to those in the art and are not described herein.

Typically, fibers are held together in paper and tissue products by hydrogen bonds and covalent and/or ionic bonds. In some instances, it may be beneficial to bond the fibers in a manner that immobilizes the fiber-to-fiber bond points and renders them resistant to disruption in the wet state, for example, when exposed to water or other aqueous solutions, blood, fats, grease, and oils. Thus, the cellulosic material optionally includes a wet strength resin. However, such wet strength resins typically decrease absorbency and, therefore, the desired properties must be balanced.

In one aspect, the absorbent material is capable of absorbing at least about 0.5 g of exudate from a food item per gram of absorbent material. In another aspect, the absorbent material is capable of absorbing at least about 1 g of exudate from a food item per gram of absorbent material. In yet another aspect, the absorbent material is capable of absorbing at least about 1.25 g of exudate from a food item per gram of absorbent material. In another aspect, the absorbent material is capable of absorbing at least about 1.5 g of exudate from a food item per gram of absorbent material. In yet another aspect, the absorbent material is capable of absorbing at least about 1.75 g of exudate from a food item per gram of absorbent material. In still another aspect, the absorbent material is capable of absorbing at least about 2 g of exudate from a food item per gram of absorbent material. In another aspect, the absorbent material is capable of absorbing at least about 2.5 g of exudate from a food item per gram of absorbent material. In another aspect, the absorbent material is capable of absorbing at least about 4 g of exudate from a food item per gram of absorbent material. In yet another aspect, the absorbent material is capable of absorbing at least about 5 g of exudate from a food item per gram of absorbent material. In another aspect, the absorbent material is capable of absorbing at least about 8 g of exudate from a food item per gram of absorbent material. In yet another aspect, the absorbent material is capable of absorbing at least about 10 g of exudate from a food item per gram of absorbent material. In still another aspect, the absorbent material is capable of absorbing at least about 12 g of exudate from a food item per gram of absorbent material. In another aspect, the absorbent material is capable of absorbing at least about 15 g of exudate from a food item per gram of absorbent material.

In another aspect, the absorbent layer comprises a polymeric material. As used herein the term “polymeric material” or “polymer” includes, but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic, and random symmetries.

Typical thermoplastic polymers that may be used with the present invention include, but are not limited to, polyolefins, e.g. polyethylene, polypropylene, polybutylene, and copolymers thereof, polytetrafluoroethylene, polyesters, e.g. polyethylene terephthalate, polyvinyl acetate, polyvinyl chloride acetate, polyvinyl butyral, acrylic resins, e.g. polyacrylate, and polymethylacrylate, polymethylmethacrylate, polyamides, namely nylon, polyvinyl chloride, polyvinylidene chloride, polystyrene, polyvinyl alcohol, polyurethanes, cellulosic resins, namely cellulosic nitrate, cellulosic acetate, cellulosic acetate butyrate, ethyl cellulose, etc., copolymers of any of the above materials, e.g., ethylene-vinyl acetate copolymers, ethylene-acrylic acid copolymers, and styrene-butadiene block copolymers, Kraton brand polymers.

In yet another aspect, the absorbent layer may comprise both a cellulosic material and a polymeric material. Examples of such materials that may be suitable include, but are not limited to, coform materials, felts, needlepunched materials, or any combination thereof.

According to one aspect of the present invention, the absorbent layer comprises a coform material formed from a coform process. As used herein, the term “coform process” refers to a process in which at least one meltblown diehead is arranged near a chute through which other materials are added to polymeric meltblown fibers to form a web. The web then may be calendared, bonded, and/or wound into a roll. Such other materials may be pulp, cellulose, or staple fibers, for example.

As used herein the term “meltblown fibers” refers to fine fibers of unoriented polymer formed from a meltblowing process. Meltblown fibers are often formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and deposited on a collecting surface to form a web of randomly disbursed meltblown fibers. Meltblown fibers may be continuous or discontinuous, and are generally smaller than 10 microns in average diameter.

As used herein, the term “nonwoven” material or fabric or web refers to a web having a structure of individual fibers or threads which are interlaid, but not in an identifiable manner as in a knitted fabric. Nonwoven fabrics or webs have been formed from many processes such as for example, spunbonding processes, meltblowing processes, and bonded carded web processes.

As used herein the term “spunbond fibers” refers to small diameter fibers of molecularly oriented polymer formed from a spunbonding process. Spunbond fibers are formed by extruding molten thermoplastic material as filaments from a plurality of fine, usually circular capillaries of a spinneret with the diameter of the extruded filaments then being rapidly reduced.

“Bonded carded web” refers to webs made from staple fibers that are sent through a combing or carding unit, which breaks apart and aligns the staple fibers in the machine direction to form a generally machine direction-oriented fibrous nonwoven web. Such fibers usually are purchased in bales that are placed in a picker that separates the fibers prior to the carding unit. Once the web is formed, it then is bonded by one or more of several known bonding methods. One such bonding method is powder bonding, wherein a powdered adhesive is distributed through the web and then activated, usually by heating the web and adhesive with hot air. Another suitable bonding method is pattern bonding, wherein heated calender rolls or ultrasonic bonding equipment are used to bond the fibers together, usually in a localized bond pattern, though the web can be bonded across its entire surface if so desired. Another suitable and well-known bonding method, particularly when using bicomponent staple fibers, is through-air bonding.

In one aspect, the absorbent layer comprises a felt. As used herein, a “felt” refers to a matted nonwoven material formed from natural and/or synthetic fibers, made by a combination of mechanical and chemical action, pressure, moisture, and heat. Any of the fibers and polymers described herein may be used to form a felt in accordance with the present invention. Thus, for example, a felt may be formed from polyethylene terephthalate or polypropylene. A felt used in accordance with the present invention may have a basis weight of from about 50 lbs/ream (3000 square feet) to about 100 lbs/ream, for example, 75 lbs/ream. In one aspect, the felt has a basis weight of from about 50 to about 60 lbs/ream. In another aspect, the felt has a basis weight of from about 60 to about 70 lbs/ream. In yet another aspect, the felt has a basis weight of from about 70 to about 80 lbs/ream. In still another aspect, the felt has a basis weight of from about 80 to about 90 lbs/ream. In a still further aspect, the felt has a basis weight of from about 90 to about 100 lbs/ream. Examples of felt materials that may be suitable for use with the present invention are those commercially available from HDK Industries (Greenville, S.C.), Hollingsworth & Vose Company (East Walpole, Mass.), and BBA Fiberweb (Charlotte, N.C.).

In another aspect, the absorbent layer comprises a needlepunched material formed from a needlepunching process. As used herein, “needlepunching” refers to a process of converting batts of loose fibers into a coherent nonwoven fabric in which barbed needles are punched through the batt, thereby entangling the fibers. Any of the fibers and polymers described herein may be used to form a needlepunched material in accordance with the present invention. For example, the absorbent layer may comprise a needlepunched spunbond material with cotton fibers and/or pulp fibers.

In any of the constructs described herein or contemplated hereby, a superabsorbent material may be used to enhance absorbency of the structure. As used herein a “superabsorbent” or “superabsorbent material” refers to a water-swellable, water-soluble organic or inorganic material capable, under favorable conditions, of absorbing at least about 20 times its weight and, more desirably, at least about 30 times its weight in an aqueous solution containing 0.9 weight percent sodium chloride. Organic materials suitable for use as a superabsorbent material in conjunction with the present invention include, but are not limited to, natural materials such as guar gum, agar, pectin and the like; as well as synthetic materials, such as synthetic hydrogel polymers. Such hydrogel polymers include, for example, alkali metal salts of polyacrylic acids, polyacrylamides, polyvinyl alcohol, ethylene, maleic anhydride copolymers, polyvinyl ethers, methyl cellulose, carboxymethyl cellulose, hydroxypropylcellulose, polyvinylmorpholinone, and polymers and copolymers of vinyl sulfonic acid, polyacrylates, polyacrylamides, polyvinylpyrridine, and the like. Other suitable polymers include hydrolyzed acrylonitrile grafted starch, acrylic acid grafted starch, and isobutylene maleic anhydride polymers and mixtures thereof. The hydrogel polymers are preferably lightly crosslinked to render the materials substantially water insoluble. Crosslinking may, for example, be accomplished by irradiation or by covalent, ionic, van der Waals, or hydrogen bonding. The superabsorbent materials may be in any form suitable for use in the absorbent structure including particles, fibers, flakes, spheres and the like. Typically the superabsorbent material is present within the absorbent structure in an amount from about 5 to about 95 weight percent based on total weight of the absorbent structure. Superabsorbents are generally available in particle sizes ranging from about 20 to about 1000 microns.

Any suitable release material may be used as desired, provided that it is acceptable for food contact, compatible with the substrate to which it is applied, and resistant to degradation at the temperature to which it is exposed. Examples of release materials that may be suitable for use with the invention include, but are not limited to, a silicone-based material, a chrome or chrome-fatty acid complex, such as QUILON® chrome complex commercially available from Zaclon, Inc. (Cleveland, Ohio), a wax, and any combination thereof. In one example, the release coating may comprise a silicone emulsion, for example, SYL-OFF 7980 Emulsion Coating or SYL-OFF 7950 Emulsion Coating, both of which are available commercially from Dow Corning (Midland, Mich.).

The release coating or additive may be applied or incorporated in any amount needed or desired for a particular application, generally from about 0.05 to about 1 lb/ream. In each of various particular examples, the release coating may be applied in an amount of from about 0.05 to about 0.08 lb/ream, about 0.08 to about 0.1 lb/ream, about 0.1 to about 0.12 lb/ream, about 0.12 to about 0.15 lb/ream, about 0.15 to about 0.18 lb/ream, about 0.18 to about 0.2 lb/ream, about 0.2 lb/ream to about 0.25 lb/ream, about 0.25 to about 0.3 lb/ream, about 0.3 lb/ream to about 0.35 lb/ream, about 0.35 lb/ream to about 0.4 lb/ream, about 0.4 to about 0.45 lb/ream, about 0.45 lb/ream to about 0.5 lb/ream, about 0.5 to about 0.55 lb/ream, about 0.55 to about 0.6 lb/ream, about 0.6 to about 0.65 lb/ream, about 0.65 to about 0.7 lb/ream, about 0.7 to about 0.75 lb/ream, about 0.75 to about 0.8 lb/ream, about 0.8 to about 0.85 lb/ream, about 0.85 to about 0.9 lb/ream, about 0.9 to about 0.95 lb/ream, or about 0.95 to about 1 lb/ream. In each of various other particular examples, the release coating may have a coat weight of from about 0.05 to about 0.5 lbs/ream, about 0.08 to about 0.3 lbs/ream, about 0.1 to about 0.2 lb/ream, about 0.11 to about 0.19 lb/ream, about 0.12 to about 0.18 lb/ream, about 0.13 to about 0.17 lb/ream, about 0.14 to about 0.16 lb/ream, or about 0.15 lb/ream. Numerous other coat weights and ranges thereof are contemplated hereby.

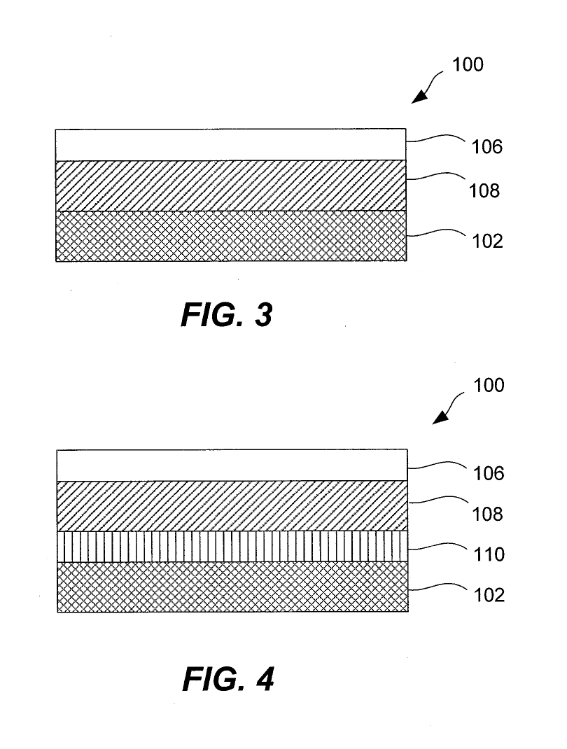

Turning to FIG. 3, the structure 100 may include a support layer or carrier 108 for the release material or coating 106. The support layer 108 serves as a barrier between the food item (not shown) and the absorbent material 102, thereby shielding the food item from loose fibers and additives contained in the absorbent structure 100. Additionally, the support layer may improve the appearance of the absorbent structure by concealing or obscuring the appearance of absorbed unsightly exudates.

The support layer may be formed from any suitable rigid or semi-rigid material, for example, a cellulosic material, a nonwoven material, a film, a paper, or any combination thereof. If needed or desired, the support layer may be provided with perforations through which exudates readily pass, as will be discussed further below. The apertures or slits may be provided in any suitable pattern or configuration as needed to achieve the desired flow through the support layer.

In one aspect, the support layer may comprise a cellulosic material. A cellulosic support layer may comprise one or more plies having a total basis weight of, for example, from about 10 to about 30 lb/ream (about 4.5 to about 13.6 kg/ream), from about 20 to about 30 lb/ream, from about 25 to about 35 lb/ream, from about 30 to about 40 lb/ream, from about 30 to about 35 lb/ream, or from about 20 to about 40 lb/ream. In one particular aspect, the cellulosic support layer has a basis weight of from about 15 to about 25 lb/ream. In another particular aspect, the cellulosic support layer has a basis weight of about 20 lb/ream. In still another particular aspect, the cellulosic support layer has a basis weight of about 30 lb/ream.

In one particular example, the support layer may comprise a paper, for example, a Kraft paper having a basis weight of from about 5 to about 30 lbs/ream, from about 20 to about 30 lb/ream, from about 25 to about 35 lb/ream, from about 30 to about 40 lb/ream, from about 30 to about 35 lb/ream, or from about 20 to about 40 lb/ream. In one aspect, the paper has a basis weight of from about 10 to about 20 lbs/ream. In another aspect, the paper has a basis weight of about 15 lbs/ream. In still another aspect, the paper has a basis weight of about 30 lb/ream.

Alternatively, the support layer may comprise a nonwoven material, such as those described above. A nonwoven support layer may comprise one or more plies having a total basis weight of from about 6 to about 70 grams per square meter (gsm). In one aspect, the nonwoven support layer has a basis weight of from about 8 to about 30 gsm. In another aspect, the nonwoven support layer has a basis weight of about 10 gsm.

Alternatively still, the support layer may comprise a film. Examples of polymeric films that may be suitable include, but are not limited to, polyolefins, polyesters, polyamides, polyimides, polysulfones, polyether ketones, or any combination thereof. More particular examples of thermoplastic materials that may be suitable for use in forming a film for use with the present invention include, but are not limited to, polypropylene, high density polyethylene, low density polyethylene, linear low density polyethylene, cellophane, polyvinyl acetate, polyvinyl alcohol, polycaprolactam, polyester, polytetrafluoroethylene, or mixtures or copolymers or coextrusions of any thereof. In one particular example, the polymeric film may comprise polyethylene terephthalate (PET). Examples of polyethylene terephthalate film that may be suitable for use as the substrate include, but are not limited to, MELINEX®, commercially available from DuPont Teijan Films (Hopewell, Va.), and SKYROL, commercially available from SKC, Inc. (Covington, Ga.).

A film support layer may have a thickness of from about 0.2 to about 1 mil. In one aspect, the film layer has a thickness of from about 0.3 to about 0.8 mil. In another aspect, the film layer has a thickness of about 0.4 mil.

It will be noted that, in some instances, the polymeric film may have sufficient non-stick characteristics so that no additional release coating is needed to prevent a food item from adhering to the absorbent construct. In other instances, a release coating (not shown) may be applied to the polymeric film to provide the desired properties. Alternatively, the release material may be incorporated into the absorbent structure, for example, within the polymeric fibers or film, such that the release material diffuses to the surface.

Any of the absorbent structures described herein or contemplated hereby may include one or more binding or adhesive layers for joining the layers. For example, as illustrated in FIG. 4, a binding layer 110 may be used to join the support layer 108 to the absorbent layer 102. The binding layer 110 may be a polymeric material, adhesive, or any other suitable material. In one aspect, the binding layer comprises polyethylene, polypropylene, or any other polyolefin or combination, blend, or copolymer thereof.

The binding layer may have any basis weight needed or desired for a particular application, and may be continuous or discontinuous in a patterned or random configuration. For example, the binding layer may have a basis weight of from about 1 to about 12 lb/ream. In each of various particular examples, the binding layer may have a basis weight of from about 1 to about 1.5 lb/ream, from about 1.5 to about 2 lb/ream, from about 2 to about 2.5 lb/ream, from about 2.5 to about 3 lb/ream, from about 3 to about 3.5 lb/ream, from about 3.5 to about 4 lb/ream, from about 4 lb/ream to about 4.5 lb/ream, from about 4.5 to about 5 lb/ream, from about 5 lb/ream to about 5.5 lb/ream, from about 5.5 lb/ream to about 6 lb/ream, from about 6 to about 6.5 lb/ream, from about 6.5 lb/ream to about 7 lb/ream, from about 7 to about 7.5 lb/ream, from about 7.5 to about 8 lb/ream, from about 8 to about 8.5 lb/ream, from about 8.5 to about 9 lb/ream, from about 9 to about 9.5 lb/ream, from about 9.5 to about 10 lb/ream, from about 10 to about 10.5 lb/ream, from about 10.5 to about 11 lb/ream, from about 11 to about 11.5 lb/ream, from about 11.5 to about 12 lb/ream, from about 12 to about 12.5 lb/ream, or from about 12.5 to about 13 lb/ream. In each of various other particular examples, the binding layer may have a basis weight of from about 5 to about 12 lbs/ream, from about 7 to about 10 lbs/ream, about 3 to about 7 lb/ream, from about 4 to about 6 lb/ream, from about 5 to about 9 lb/ream, from about 6 to about 8 lb/ream, from about 4 to about 10 lb/ream, or about 8 lb/ream. Numerous other coat weights and ranges thereof are contemplated hereby.

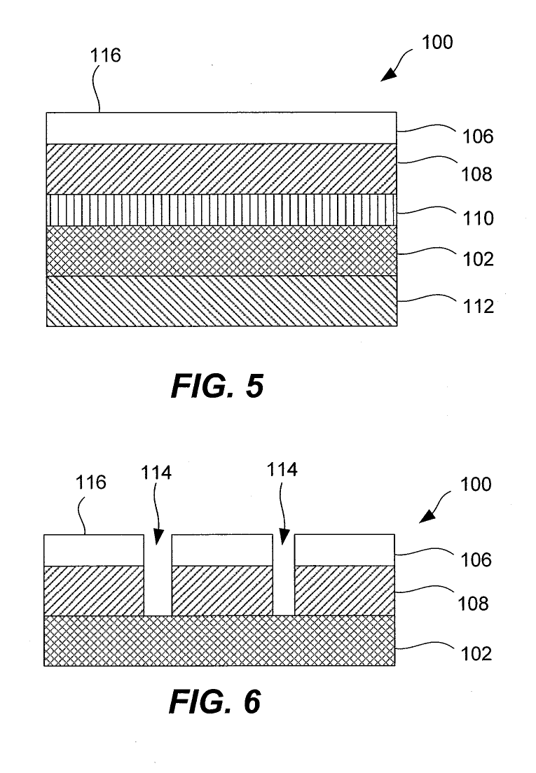

Turning to FIG. 5, the structure 100 may include a liquid impervious layer 112 to contain the exudates released from the food item and to help to maintain a dry feel when grasped by a user. Additionally, the liquid impervious layer 112 may prevent the exudates from leaking from a package in which the absorbent structure 100 is incorporated.

Any hydrophobic and/or oleophobic material may be used to form the liquid impervious layer. Examples of materials that may be suitable include, but are not limited to polyolefins, such as polypropylene, polyethylene, and copolymers thereof, acrylic polymers, fluorocarbons, polyamides, polyesters, polyolefins, acrylic acid copolymer, partially neutralized acid copolymers, and paraffin waxes. These materials may be used individually, as mixtures, or in coextruded layers.

The thickness of the film typically may be from about 40 to about 55 gauge. In one aspect, the thickness of the film is from about 43 to about 52 gauge. In another aspect, the thickness of the film is from about 45 to about 50 gauge. In still another aspect, the thickness of the film is about 48 gauge.

The liquid impervious layer may be formed using any suitable method, technique or process known in the art including, but not limited to, lamination, extrusion, and solution coating. Thus, the liquid impervious layer may be a film that is laminated to the construct, or may be applied as a solution, molten polymer, or the like directly to the construct.

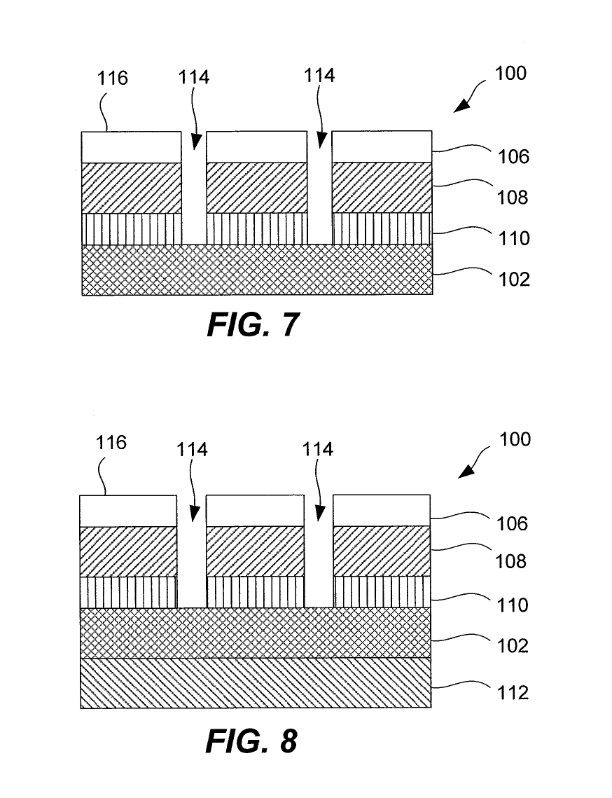

As shown in FIG. 6, a plurality of partial slits, apertures, embossments, or perforations 114 (collectively “perforations”) may be provided in any of the various structures 100 of the invention to define a pathway from the food-contacting surface 116 through the various layers to the absorption layer 102. For example, the structure 100 of FIG. 3 may include perforations 116 extending through layers 106 and 108, as shown in FIG. 6. In this way, exudate from a food item (not shown) seated on the food contacting surface may travel through the perforations 114 and be absorbed in the absorbent layer 102. As another example, the structure 100 of FIG. 4 may include perforations 114 extending through layers 106, 108, and 110, as shown in FIG. 7. As yet a further example, the structure 100 of FIG. 5 may include perforations 116 extending through layers 106, 108, 110, and 112, as shown in FIG. 8. In this example, any exudate that passes through the absorbent layer 102 may be contained by the liquid impervious layer 112. In any of such examples, the support layer 108 may alternatively or additionally include one or more slits or perforations through which the exudate may pass.

If desired, the perforations may extend through the entire thickness of the construct. In such arrangements, the exudates will be absorbed primarily in the absorbent layer, but some liquid may be left on the microwave tray or other surface on which the absorbent structure is used. Although shown in particular arrangements herein, the perforations may have or be arranged in numerous possible shapes such as circles, ellipses, trapezoids, or any other shape needed or desired. The number and arrangement of perforations may vary depending on the liquid content of a food item intended for placement on or in the construct, and any number of other factors.

The absorbent constructs of the present invention may be used to form numerous products for various packaging and heating applications.

According to one aspect of the present invention, the absorbent construct is provided to the user for use with a variety of foods and cooking devices. The absorbent construct may be provided in various forms, and the user maintains a supply of the absorbent structure for use when needed.

For example, the absorbent structure may be used to form a pre-cut, disposable absorbent sheet for use in personal (home, work, travel, camping, etc.), commercial (e.g., restaurant, catering, vending, etc.), or institutional (e.g., university, hospital, etc.) applications. The sheet may be provided in any shape, for example, a square, rectangle, circle, oval, polygon, star, diamond, or any other pattern. The sheet may be provided in various sizes, depending on whether the intended use is for a microwave oven, conventional oven, toaster oven, hot plate, electrical skillet, or grill. For example, the sheet may be cut to fit standard plate sizes, pans, or baking sheets. The sheet may be individually wrapped for travel use, or may be provided as a wrapped stack of a plurality of sheets. The sheets may be provided in a box or a pouch. The sheets may be provided in a pop-up or pull-down dispenser, and may include individual folding or interfolding such as C-folding or tri-folding.

If desired, the absorbent sheet may be used to cook items in a microwave oven. More particularly, the absorbent sheet may be used to cook bacon in a microwave oven. In such an instance, the absorbent sheet is dispensed from the package and optionally placed on a plate or tray. The bacon is placed on the absorbent structure. As the bacon cooks in the microwave oven, the fat drains away from the bacon strips and passes through any other layers of the absorbent structure so it then can be absorbed by the absorbent layer. As a result, the cooked bacon is less greasy and more crispy. The absorbent structure then is discarded conveniently with the fat therein.

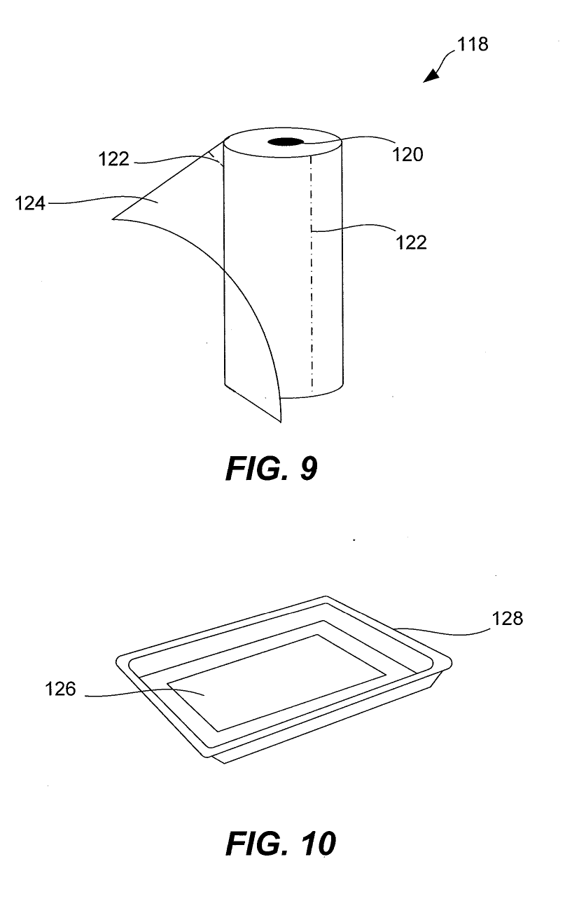

Alternatively, the absorbent structure may be provided to the user as a roll 118 of absorbent material, as shown in FIG. 9. In one aspect, the roll is formed from a continuous sheet having a longitudinal dimension and a transverse dimension. The roll is formed by winding the material, optionally on a core 120, in the longitudinal direction. The roll may include transverse perforations 122 at spaced positions along the longitudinal dimension so that the user can tear a sheet 124 from the roll. The user can tear one or more sheets individually, or unwind the roll to remove two or more adjoined sheets where needed for use in a microwave oven, conventional oven, toaster oven, electric skillet, grill, or other cooking device. In another aspect, a roll is formed from a plurality of overlapping sheets (not shown), which may be contained in a flexible or rigid container with, for example, a lid with an opening for easy removal of the outermost sheet in the roll. The absorbent sheet is then dispensed through the opening in the lid.

According to another aspect of the present invention, the absorbent structure may be provided as an absorbent sheet 126 for use in a tray or other container, for example, with the conventional tray 128 illustrated in FIG. 10. The particular form of the food container and/or packaging itself may comprise any one of numerous forms known to those skilled in the art such as, for example, wrapped trays, cardboard boxes, plastic containers, sealable bags, etc. In one aspect, the absorbent sheet is provided with a particular food item, but is maintained separate from the food item within the package until cooking. In another aspect, the food item is placed in intimate contact with the food item in the package. In this aspect, the absorbent sheet absorbs exudates before cooking and during and/or after cooking. The sheet may be attached to the tray or container, or may be held in position by the food item supported thereon.

When used with packaged meat and poultry, the absorbent structure may be placed over the central portion of a foam or plastic tray. Although rectangular configurations are most common, the actual dimensions of the tray can vary considerably depending on the nature and amount of product intended to be packaged. The absorbent structure may be sized to fit the tray as a single continuous unit or configured to overlay the tray in sections. Further, although the absorbent sheet can be simply placed over a support tray prior to placing the product thereon, the absorbent sheet may be permanently attached to the tray to prevent movement of the same in handling. As an example, the absorbent sheet may be adhesively attached to the tray. In addition, the absorbent sheet may be made an integral part of the tray itself.

As another example, the absorbent sheet may be provided in a tray in a package of meat, for example, bacon. The absorbent sheet may be contained in the package separate from the bacon, which typically is wrapped in a food grade plastic. The user positions the absorbent sheet on the tray, unwraps the bacon, and places the bacon on the absorbent sheet. The tray with the absorbent sheet and bacon is placed in the microwave oven for cooking. As the bacon cooks, the fat drains from the bacon and is contained in the absorbent layer.

Alternatively, the absorbent sheet may be positioned on the tray with the bacon thereon, and the entire tray containing the bacon and absorbent sheet may be wrapped in food grade plastic. In this instance, the user unwraps the tray and places the tray with the bacon and absorbent sheet in the microwave oven for cooking. Alternatively yet, the bacon on the absorbent sheet may be wrapped jointly, and the wrapped bacon and absorbent sheet placed on the tray within the package. In this instance, the user unwraps the bacon and absorbent sheet and places them on the tray for cooking. After cooking, the bacon is removed and the absorbent sheet and the tray are discarded.

The various constructs of the present invention may be formed according to a number of different processes. Such processes are well known to those of skill in the art and are described only briefly herein.

Each layer of the absorbent structure may be prepared and supplied as a wound roll of material. The layers may then be unwound, superposed, and bonded to form the absorbent structure. The layers may be adhesively bonded, mechanically bonded, thermally bonded, ultrasonically bonded, or any combination thereof, as described above. The degree and type of bonding is selected to provide sufficient structural integrity without impeding the flow of exudates to the absorbent layer.

Examples of thermal bonding processes include, but are not limited to, calendaring, through-air bonding, and point bonding. Point bonding involves passing the materials to be bonded between a heated calender roll and an anvil roll. The calender roll is usually, though not always, patterned so that the entire fabric is not bonded across its entire surface, and the anvil roll is usually flat. As a result, various patterns for calender rolls have been developed for functional as well as aesthetic reasons. Mechanical bonding includes use of staples, stitches, grommets, and other fasteners to join the layers. Adhesive bonding techniques employ, for example, adhesive tape, hot melt adhesives, and various curable adhesives. Ultrasonic bonding comprises passing the materials to be bonded between a sonic horn and anvil roll to convert mechanical energy to heat. In one aspect, a polymeric layer, such as polypropylene, polyethylene, or a combination or copolymer thereof, is applied between one or more other layers to join the layers.

The layers to be joined are selectively bonded to achieve a balance between structural integrity, strength, and permeability. In general, bonding increases strength and structural integrity, but decreases permeability. In one aspect, the peripheral edges are at least partially unbonded, so that exudates that have run off the food-contacting surface may be absorbed through the edges. The absorbent structure then may be wound into a roll, die cut, and packaged.

Alternatively, one or more of the various layers of the absorbent structure may be formed as part of a continuous process. Thus, for example, a release coating may be applied to a substrate, for example, a paper or nonwoven, and wound into a roll. Separately, a base sheet may be formed, and the absorbent layer may be formed thereon and bonded thereto using a polymeric binder. To assemble the absorbent structure, the two composites are brought together, superposed, bonded as described above, and made into the finished roll, sheet, pad, or other construct.

In one aspect, adhesive is applied between the perforation lines so the adhesive does not obstruct the flow of exudates through the perforations. By applying the adhesive in this manner, one or more of the various layers may be perforated prior to assembly of the construct. In another aspect, the construct may be assembled and any adhesive allowed to dry prior to perforating the various layers.

Accordingly, it will be readily understood by those persons skilled in the art that, in view of the above detailed description of the invention, the present invention is susceptible of broad utility and application. Many adaptations of the present invention other than those herein described, as well as many variations, modifications, and equivalent arrangements will be apparent from or reasonably suggested by the present invention and the above detailed description thereof, without departing from the substance or scope of the present invention.

Although numerous embodiments of this invention have been described above with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are only used for identification purposes to aid the reader's understanding of the embodiments of the present invention, and do not create limitations, particularly as to the position, orientation, or use of the invention unless specifically set forth in the claims. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

It will be recognized by those skilled in the art, that various elements discussed with reference to the various embodiments may be interchanged to create entirely new embodiments coming within the scope of the present invention. It is intended that all matter contained in the above description or shown in the accompanying drawings shall be interpreted as illustrative only and not limiting. Changes in detail or structure may be made without departing from the spirit of the invention as defined in the appended claims. The detailed description set forth herein is not intended nor is to be construed to limit the present invention or otherwise to exclude any such other embodiments, adaptations, variations, modifications, and equivalent arrangements of the present invention.

What is claimed is:

1. An absorbent sheet comprising:
a non-stick food-contacting surface comprising a silicone, a chrome complex, a wax, or any combination thereof; and
an absorbent layer comprising polyethylene terephthalate.

2. The absorbent sheet of claim 1, wherein the silicone, chrome complex, wax, or combination thereof is supported by a perforated carrier.

3. The absorbent sheet of claim 2, further comprising a polypropylene binding layer between the carrier and the absorbent layer.

4. The absorbent sheet of claim 1, wherein the absorbent layer comprises polyethylene terephthalate felt having a basis weight of from about 50 to about 100 lbs/ream.

5. A tray comprising the absorbent sheet of claim 1.

6. A roll of absorbent material comprising at least two overlapping absorbent sheets according to claim 1.
